(19) United States
(12) Patent Application Publication
(10) Pub. No.: US 2014/0058811 A1
(43) Pub. Date: Feb. 27, 2014

(54) SYSTEM AND METHOD FOR MONITORING AND REWARDING AN INCENTIVIZED ACTIVITY

(71) Applicant: PRODEGE, LLC, Torrance, CA (US)

(72) Inventors: Yosef Gorowitz, Redondo Beach, CA (US); Scott Dudelson, Malibu, CA (US); Ron Leshem, Los Angeles, CA (US); Levy Lieberman, Redondo Beach, CA (US); Shmuel Pinson, Los Angeles, CA (US); Connor Morozow, Redondo Beach, CA (US); Menachem Pinson, Los Angeles, CA (US)

(73) Assignee: PRODEGE, LLC, Torrance, CA (US)

(21) Appl. No.: 13/831,062

(22) Filed: Mar. 14, 2013

Related U.S. Application Data
(63) Continuation of application No. PCT/US20/46319, filed on Jul. 11, 2012.
(60) Provisional application No. 61/506,179, filed on Jul. 11, 2011.
(60) Provisional application No. 61/544,465, filed on Oct. 7, 2011.

(51) Int. Cl. G06Q 30/02

(52) U.S. Cl. CPC G06Q 30/0231
USPC 705/14.12; 705/14.31

(57) ABSTRACT

A system and method for monitoring and rewarding a user's participation in an incentivized activity is constructed and arranged to verify that the user is engaging in the incentivized activity as a condition for awarding an incentive. The system may be configured to verify whether the user is engaging in the incentivized activity at all, or to monitor the quality of the user's participation in the incentivized activity. The incentivized activity could be any online activity, activity that occurs on an interactive television system or activity that occurs on a mobile device such as a smart phone or tablet computer.

### CROSS-REFERENCE TO RELATED PATENT APPLICATIONS

The present application is a continuation of International application no. PCT/US2012/046319 filed Jul. 11, 2012, which claims the benefit of United States provisional patent application entitled “System to Monitor and Reward Watching Video” with Ser. No. 61/506,179 filed on Jul. 11, 2011, and which also claims the benefit of United States provisional patent application entitled “System and Method for Monitoring and Rewarding Incentivized Activity” with Ser. No. 61/544,465 filed on Oct. 7, 2011. The disclosure of each of these prior applications is expressly incorporated herein by reference in its entirety.

### FIELD OF THE INVENTION

This invention generally relates to monitoring a person's participation in an activity, such as viewing a video on a web site, as well as the quality of such participation. More specifically, the present invention relates to a system and method that allows a person participating in such activities to earn a reward by completing a series of discrete transactions which are monitored to ensure the transactions comply with a threshold level of quality.

### BACKGROUND OF THE INVENTION

A business model exists wherein participants such as individuals using the Internet are incentivized to engage in an activity such as viewing a video, playing a game or reading digital content. An example of such a business model may be found on the Internet at www.swagbucks.com, wherein virtual currency that is redeemable for prizes is awarded to a participant in exchange for engaging in certain Internet activity.

Such a business model may become less valuable if it is possible for a participant to receive the incentive without truly engaging in the incentivized activity.

### SUMMARY OF THE INVENTION

Accordingly, it is an aspect of the invention to provide a system and method for monitoring a person's participation in an incentivized activity. It is another aspect of the invention to provide a system in which rewards for engaging in an incentivized activity are verified by user interaction.

### BRIEF DESCRIPTION OF THE DRAWINGS

The accompanying drawings, which are incorporated herein and constitute part of this specification, illustrate an embodiment of the invention, and together with the general description given above and the detailed description given below, serve to explain features of the invention.

FIG. 1 is a schematic diagram of an example network environment, including an application delivery network which may be used to practice the present invention.

FIG. 2 is a schematic diagram of a system for rewarding quality end user interaction with digital information according to a preferred embodiment of the present invention.

FIG. 3 is a process flow chart depicting a method for awarding an incentive to an end user according to a first embodiment of the present invention.

FIG. 4 is a process flow chart depicting a method for awarding an incentive to an end user according to a second embodiment of the present invention.

FIG. 5A is a process flow chart depicting a first part of a method for rewarding quality end user interaction with digital information according to a preferred embodiment of the present invention.

FIG. 5B is a process flow chart depicting a second part of the method of FIG. 5A.

FIG. 6 is a schematic depiction of a system that is constructed according to another embodiment of the invention.

FIG. 7 illustrates exemplary computer system architecture that may be used to implement the present invention.

### DETAILED DESCRIPTION OF THE INVENTION

Embodiments of the present invention are directed to a reward application and reward application delivery network that allows end users to earn rewards for interacting with information that may be delivered by a content provider network.

In one aspect of the present invention, an end user earns a reward from the reward application delivery network by completing a series of discrete transactions with digital information. In another aspect of the present invention, the reward application delivery network monitors end user transactions and analyzes data obtained from the transactions to validate a threshold level of interaction quality between the end user participating in the transaction and the information that forms the basis of the transaction.

In another aspect of the present invention, certain content provider networks may implement a points system for statistical reasons and not reward end users with virtual currency or other prizes. For example, an educational content provider network may use the system and methods of the present invention to measure student progress and recognize levels of performance accordingly.

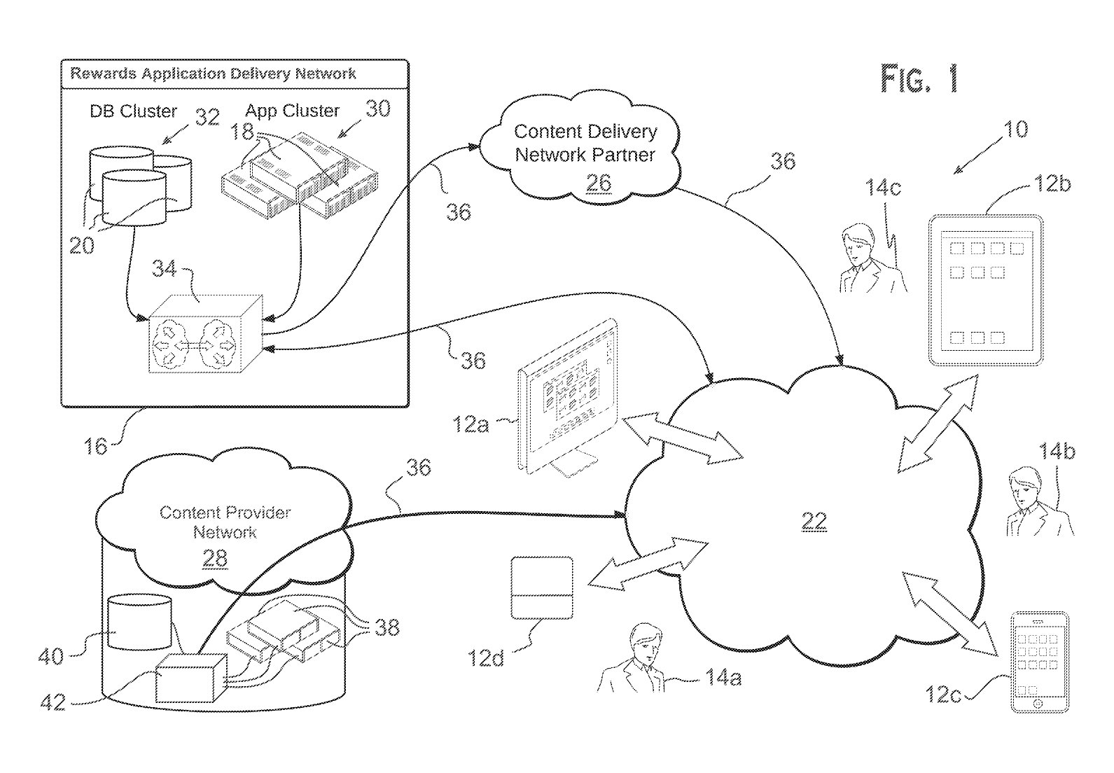

Referring now to the drawings, wherein like reference numerals designate corresponding structure throughout the views, and in particular to FIG. 1, an exemplary wide area network system 10 may include computing systems 12 that allow end users 14 to access and interact with digital information. This digital information may be stored or embodied as content objects in a data file, database or record. Content objects may take many forms, including: text (e.g., ASCII, SGML, and HTML), images (e.g., jpeg, tiff and gif), graphics (vector-based or bitmap), audio, video (e.g., mpeg), or other multimedia, and combinations thereof. Content objects also may include executable code objects (e.g., games executable within a browser window or frame), and podcasts.

Reward application delivery network 16 may be configured as an addressable application delivery network that includes one or more physical application servers 18 and database servers (or data store) 20. The one or more physical servers 18 may be connected to computer network 22 via, by way of example, a set of routers and/or networking switches 34. In an example embodiment, the functionality hosted by the one or more physical servers 18 may include web or HTTP servers, FTP servers, as well as, without limitation, web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX).

Reward application delivery network 16 may operate in a wide area network environment 10, such as the Internet, including multiple network addressable systems. Network cloud 22 generally represents one or more interconnected networks, over which the systems and hosts can communicate. Network cloud 22 may include packet-based wide area networks (such as the Internet), private networks, wireless networks, satellite networks, cellular networks, paging networks, and the like.

In a preferred embodiment, the reward application delivery network 16 may operate in a wide area network environment 10 that includes a content delivery network partner 26, an independent content provider network (or content provider) 28, and one or more personal computing systems (or devices) 12 operated by end users 14 that are registered members of the reward application delivery network 16. The devices 12 may be connected to the network environment 22 via a network service provider, a wireless carrier, or any other suitable means.

Generally, reward application delivery network 16 may include a set of connected computers 18, 20 that work together so that in many respects they may be viewed as a single system. The reward application delivery network 16 may include an application server cluster 30, a database server cluster 32, and a primary network switch 34.

The application server cluster 30 may be a group of computers used as servers 18, which are individually configured to host software applications under the heavy demand of the network 16. A computer 18 in the application server cluster 30 may include a faster CPU, increased high-performance RAM, and increased storage capacity in the form of a larger or multiple hard drives. For example, a computer 18 in the application server cluster 30 may be configured with an Intel Xeon Processor E5640 @ 2.66 GHz/8 GB RAM/2×160 GB 15 k SAS drives—RAID 1/1 Gbit network card and use Windows Server (2008) operating system. The computers 18 in the application server cluster 30 may further include fault tolerant features, such as in power supplies, storage (as in RAID), and network connections. Proprietary application servers that may be suitable for use in the application server cluster include IIS, Zend, JBoss, and Apache Tomcat.

The database server cluster 32 may be a group of computers used as servers 20 that are configured to host software applications which provide database services to other computers in the network 16. In FIG. 1, the computers 20 in the database server cluster 32 provide database services to the computers 18 in the application server cluster 30. A computer 20 in the database server cluster 32 may include a faster CPU, increased high-performance RAM, and increased storage capacity in the form of a larger or multiple hard drives. For example, a computer 20 in the database server cluster 32 may be configured with 2× Intel Xeon Processor E5680 @ 3.33 GHz/16 GB RAM/10×160 GB 15 k SAS drives—RAID 10/2×1 Gbit network cards and use a LINUX Debian operating system. These computers 20 may further include fault tolerant features, such as redundancy in power supplies, storage (as in RAID), and network connections. The database servers 20 may be proprietary or public license database servers. Proprietary database servers that may be suitable for use in the database server cluster include, but are not limited to, Oracle, DB2, Informix, or Microsoft SQL servers.

Generally, network switch (or switching hub) 34 may be a computer networking device that connects network segments or network devices. In FIG. 1, primary network switch 34 connects the application server cluster 30 and the database server cluster 32 between themselves and to edge routers (not shown), which are connected to an Internet Service Provider 36 that provides the routers access to the Internet 22.

The primary network switch 34 may manage data between the networked segments or devices. In FIG. 1, the network switch 34 may provide server-load balancing. Server-load balancing uses one or more techniques including service-based (global load balancing) or hardware-based, e.g., layer 4-7 switches, also known as a web switch, content switch, or multilayer switch, to share traffic among a number of servers or web caches. Switches that may be suitable for use in the primary network switch 34 include Cisco CSS 11503.

The primary network switch 34 may be assigned a combination of dedicated or virtual IP addresses. Traffic arriving at the switch 34 may be directed to one of the real application servers 18 within the application server cluster 30 that are connected to the switch. Approaches to load-balancing may include a simple round-robin method of assigning each new request to a different server (or node) or may be based on more complex algorithms.

A content delivery network partner 26 may be used to store content from the reward application delivery network and then serve the stored content to devices 12 of reward application deliver network end users 14. For example, the content delivery network partner 26 may store cacheable content from the reward application delivery network 16 and then deliver this content to an end user device 12 upon request.

Preferably, high demand static content objects in JPG, GIF, CSS, JS, HTML, PDF and other file formats may be stored on the content delivery network partner for delivery to end user devices 12. For example, a profile picture may be uploaded to the content delivery network partner 26, and the end user device then may be directed by the reward application delivery network 16 to fetch the image from the content delivery network partner 26. One provider of a cloud platform for delivering secure, cacheable content to end user devices in such a manner is Akamai of Cambridge, Mass.

Content provider network 28 may be an independent content management system which provides content for end users 14 to view or interact with through a user interface provided over a telecommunication system, network, or Internet Website. For example, YowGo Entertainment TV provides an Internet destination site to search and view free online videos of movies, television shows, cartoons, news or other content on the Web.

The content provider network 28 may be a network addressable system that includes one or more physical servers 38 and data store 40. One or more physical servers 38 may be connected to computer network 22 via, by way of example, a set of routers and/or networking switches 42. The functionality hosted by the one or more physical servers 38 may include web or HTTP servers, FTP servers, as well as, without limitation, web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), and the like.

Physical servers 38 may host functionality directed to the operations of content provider network 28. By way of example, content provider network 28 may host a website that allows one or more users 14 to view videos. Data store 40 may store content and data relating to and enabling operation of the content provider network as digital data objects.

As previously described, a data object may be an item of digital information typically stored or embodied in a data file, database or record. Content objects may take many forms, including: text (e.g., ASCII, SGML, and HTML), images (e.g., jpeg, tiff and gif), graphics (vector-based or bitmap), audio, video (e.g., mpeg), or other multimedia, and combinations thereof. Content object data also may include executable code objects (e.g., games executable within a browser window or frame), podcasts, etc.

Logically, data store 40 corresponds to one or more of a variety of separate and integrated databases, such as relational databases and object-oriented databases that maintain information as an integrated collection of logically related records or files stored on one or more physical systems. Structurally, data store 40 may generally include one or more of a large class of data storage and management systems.

For example, data store 40 may be implemented by any suitable physical system(s) including components, such as one or more database servers, mass storage media, media library systems, storage area networks, data storage clouds, and the like. In another example, data store 40 includes one or more servers, databases (e.g., MySQL), and/or data warehouses.

End user device 12 is generally a computer or computing system including functionality for communicating (e.g., remotely) over a computer network. The device 12 may be a personal computer 12a, a tablet computer 12b, a smart phone or other cellular or mobile phone 12c, or gaming device 12d, among other suitable computing devices. Device 12 may execute one or more client applications, such as a web browser (e.g., Microsoft Windows Internet Explorer, Mozilla Firefox, Apple Safari, Google Chrome, and Opera, etc.), to access and view content over a computer network.

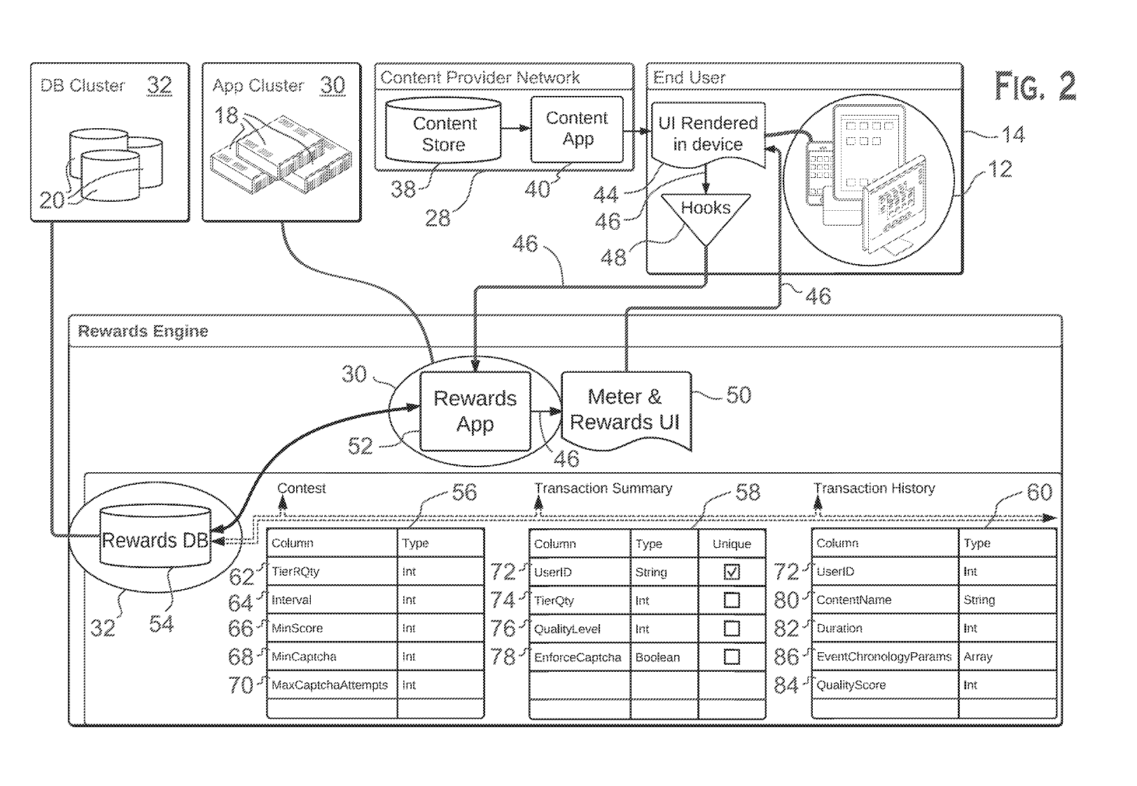

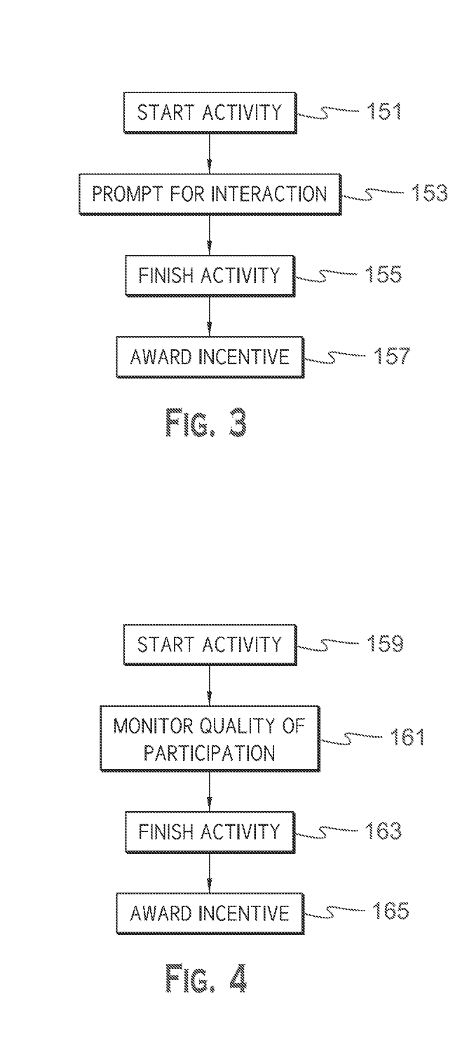

Referring to FIG. 2, content provider network 28 may provide content to an end user device 12 via a user interface 44 such as a browser or a mobile application (or mobile app). Generally, a mobile application is a software application designed to run on smart phones, tablet computers, video game consoles (e.g., Xbox, PlayStation, and Wii), and other mobile devices.

The user interface 44 may include a link (or channel) 46 to the reward application delivery network 16. The link may be implemented by software provided by the administrators of the content provider network 28 in coordination with the administrators of the reward application delivery network 16. Preferably, these software programs may be implemented in JavaScript for browsers or mobile API for mobile applications.

For example, an end user 14 may initiate a call to the content provider network 28 via a web link from within a browser on the end user's device. The content provider network 28 may respond to the call by sending content provider user interface elements 44 which display and organize the content to be delivered. In addition, the content provider network 28 may establish a link (or channel) 46 via JavaScript to the rewards application 52, which in turn may send rewards application user interface elements 50 to the browser via the newly established JavaScript channel 46.

In another example, an end user 14 may initiate a call to the content provider network 28 via a web link by initializing an application on a mobile device. The content provider network 28 may respond to the call by sending rendering instructions that allow the application to display and organize the content to be delivered. In addition, the content provider network 28 may establish a link (or channel) 46 via an API response to the rewards application 52 which in turn may send rendering instructions relating to the rewards components via the API response. In this case, the rewards application user interface elements 50 are rendered by the mobile application using the instructions provided by the API response.

Although the link 46 may be implemented with code written in JavaScript for web browsers or mobile API for mobile applications, the link may be implemented using any suitable software development kit (SDK) or programming language or technique, provided that the link opens a channel to the reward application delivery network 16 from the user interface 44 which is capable of transmitting data between a software agent associated with the user interface and the reward application delivery system.

The software that establishes the link 46 further may include (or interact with) a hook 48, which is code that intercepts function calls, events, messages or other information from the user interface 44.

Generally, a hook 48 may be deployed to the user interface 44 to determine the unique identity of the end user 14, the content identification of the transacted information, the duration of the transaction, and the quantity of information that was consumed by the end user. Additionally, a hook 48 may be deployed to detect DOM window events for the reward application to use in assessing the quality of the transaction. Exemplary hooks which may be used include: WindowFocus, WindowResize, InputFocus, MouseMovement, and TimeZoneChange.

The user interface 44 further may include a reward application user interface 50. The reward application user interface 50 may be a window within the user interface 44 that displays messages and information to the end user 14. Messages displayed in the reward application user interface 50 may provide feedback to the end user relating to the quality of the end user's interaction with the user interface 44. The feedback, without limitation, may take the form of queries, text messages, award or coupon redemption codes, images, or graphical elements sent from the reward application delivery network 16 to the window 50 via the end user device—reward application delivery network link 46. For example, the reward application user interface 50 may include a graphic representation of a meter that depicts the end user's current tier count, as well as the target tier count for earning a reward.

The reward application user interface 50 may further collect information directly from the end user device 12 and transmit this information to the reward application network 16 via the end user device—reward application network link or channel. For example, the reward application user interface may be used to convey a captcha screen to the end user.

Functionality hosted by the one or more physical servers 18 may include a rewards application 52. The rewards application 52 may be a software program implemented in a programming language such as, PHP, Java, JSP, XML, JavaScript, C#, and .NET Framework. Rewards database 54 may store content and data relating to and enabling operation of the rewards application 52 as digital data objects (described above).

Rewards database 54 may be housed in database cluster 32, which as previously described may be one or more of a variety of separate and integrated databases, such as relational databases and object-oriented databases that maintain information as an integrated collection of logically related records or files stored on one or more physical systems. Rewards database 54 may include a Contest table 56, a Transaction Summary table 58, and a Transaction History table 60.

Contest table 56 may contain parameters and settings that define the contest rules by which an end user 14 can earn a reward for interacting with content supplied by the Content Provider Network 28 onto a device 12 associated with the end user 14. In one embodiment, the Contest table may include the following columns: TierRQty 62, Interval 64, MinScore 66, MinCaptcha 68, and MaxCaptchaAttempts 70.

TierRQty may be defined as the number of authenticated transactions that need to be completed by an end user in order to receive an award. The Interval parameter may be defined as a metric that corresponds to the minimum amount of an entire transaction that must be completed by an end user in order for the transaction to count toward the tier goal. More particularly, in one embodiment the Interval parameter may be the minimum duration of an entire transaction completed by an end user in order for the transaction to count. For example, if the Interval parameter is set to five minutes, then the completed transactions must last for at least five minutes in order for the transaction to count toward the tier goal. In another embodiment, the Interval parameter may be the minimum number of web pages in a document that must be accessed. In another embodiment, the Interval parameter may be the minimum number of lines on a single web page that must be rolled over. MinScore may be defined as the minimum quality score assigned to the transaction by a quality algorithm that indicates the requisite quality of the transaction has been validated. MinCaptcha may be defined as the minimum captcha score assigned to the transaction by the quality algorithm that indicates the quality of a transaction is insufficient to be validated directly. MaxCaptchaAttempts may be defined as the maximum number of attempts an end user may receive in order to respond correctly to a captcha screen.

An administrator may set values for these parameters in the Contest table. Alternatively, the administrator may select to have values for these parameters set automatically by the rewards application. For example, the rewards application may be instructed to update or change some parameter values in the Contest table randomly, or at specific or random intervals. An administrator may further select whether the end user device is informed of the TierRQty.

Transaction Summary table 58 may store current summary values (or arguments) for parameters associated with each end user participating in the contest. The columns in this database may include UserID 72a, TierQty 74, QualityLevel 76 and EnforceCaptcha 78.

UserID may be defined as a unique alphanumeric string that identifies one specific user. TierQty may be an integer number that corresponds to the number of authenticated transactions completed by the user during a transaction-reward cycle. QualityLevel may be defined as the Quality score assigned to the latest transaction by the quality algorithm, and Enforce Captcha may be defined as a Boolean data type that indicates whether the user is required to successfully match a captcha before receiving a contest reward.

Transaction History table 60 may store all data transmitted to the rewards application during a transaction via hooks or similar techniques associated with the user interface. The columns in this database may include: UserID 72b, ContentName 80, Duration 82, QualityScore 84, and EventChronologyParams 86.

Previously defined, UserID may be a unique alphanumeric string that identifies one specific user. ContentName may be a unique alphanumeric string that identifies one specific content object. Duration may be an integer value that measures the time period between the transaction request that initiated the transaction and the transaction request that terminates the transaction.

QualityScore may be an integer value of the Quality score assigned to the transaction by the quality algorithm, and EventChronologyParams may be an array of data associated with the transaction that describe a detailed chronology of the end user's interaction with the user interface during the transaction.

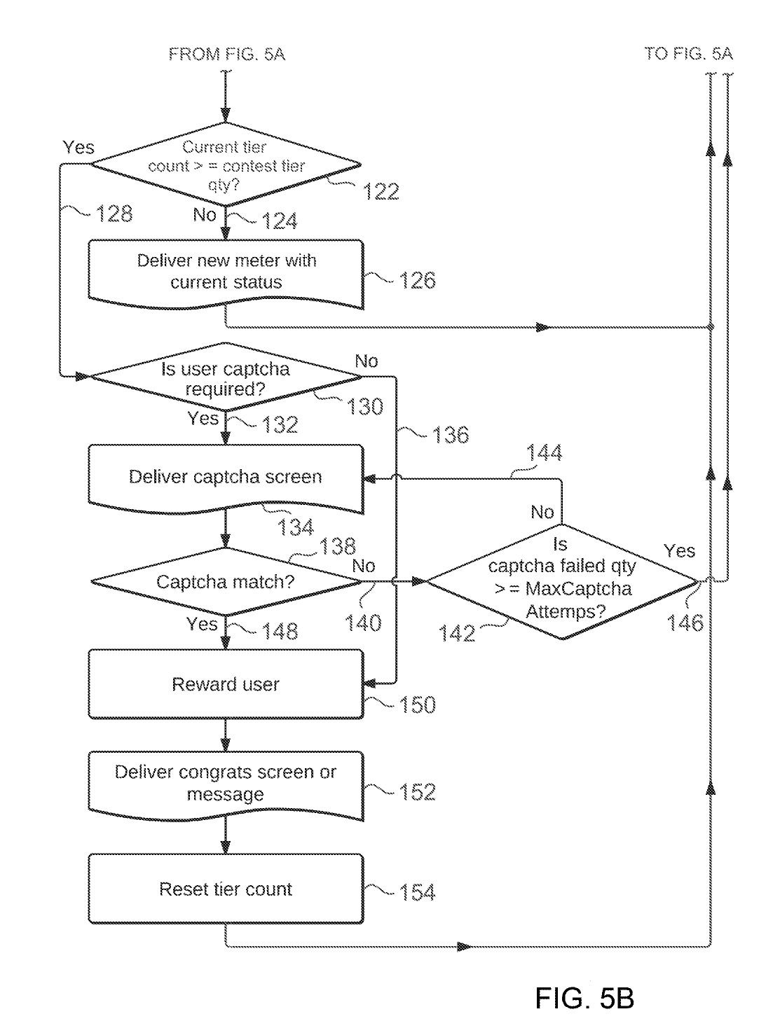

A method of rewarding a user for quality interaction with content on a computing device now will be described with general reference to block diagram of FIG. 2 and the flowchart of FIGS. 5A and 5B.

Rewards application server 18 starts the reward application 52. When an end user 14 opens a data object in the user interface 44, a hook 48 associated with the user interface 44 identifies that a new transaction has been requested 90 by the end user. A link or channel between the user interface 44 for displaying the requested content and the reward application is opened. The hook or another agent collects and sends information about the request to the reward application. The information may include the UserID of the end user and the Content Name of the requested data object. These data are then stored 92 in the Transaction History table 60 in the UserId 72 and ContentName 80 columns, respectively.

Hooks associated with the user interface continue to collect and transmit information 94 about the interaction between the end user and the user interface in which the requested data object is rendered. The reward application 52 stores these data in the EventChronologyParams 86 column of the Transaction History table 60, until a new transaction request is received 90 or a transaction end request is received 96.

After a new transaction request is received, the duration of the transaction is calculated 98 and stored in Duration 82 column of the Transaction History table 60. The reward application compares the duration of the transaction to the Interval setting found in the Interval column 64 of the Contest table 56. If the duration of the transaction is less than the interval setting 100, the transaction is rejected and the rewards engine continues to receive and actively fetch quality indicators 94 from the subsequent transaction. If the duration of the transaction meets or exceeds the interval setting 102, however, the quality indicators that are stored in the EventChronologyParams column 86 of the Transaction History table 60 are processed by a quality algorithm 104.

A quality algorithm may be used to generate a quantitative measure of the level of interaction between an end user and the content delivered to the end user's device.

Table 1 is an exemplary embodiment of code that tracks user quality based on quality metrics. The code calculates the quality score of a transaction by assigning an initial quality score and then deducting points for certain incidents it recognizes as “suspicious” or characteristic of a low quality transaction. The quality metrics used in this embodiment are WindowFocus, WindowResize, InputFocus, MouseMovement, and TimeZoneChange.

TABLE 1
Program Listing for Implementing a Quality Algorithm

```
public class QualityTracker {
  Map<Integer, List<TransactionQualityInfo>> transactionMap;
  QualitySettings qualitySettings;
  public int startNewTransaction( ) {
```

int transactionID = new Random( ).nextInt( );
List<TransactionQualityInfo>( ) list = new
ArrayList<TransactionQualityInfo>( );
list.add(newTransactionQualityInfo(QualityMetric.TransactionStart));
transactionMap.put(transactionID, list);
return transactionID;

```
  }
  public void addTransactionQualityInfo(int transactionID,
  QualityMetric metric) {
```

transactionMap.get(transactionID).add(new

```
TransactionQualityInfo(QualityMetric.TransactionStart));
  }
  public QualityScore compleateTransaction(int transactionID) {
```

```
List<TransactionQualityInfo> list =
transactionMap.remove(transactionID);
int startingScore = qualitySettings.startingScore;
int prevTime = 0;
for(TransactionQualityInfo info : list) {
  startingScore =−
  qualitySettings.scorePerInstance.get(info.metric);
  if(prevTime > 0 ) {
```

startingScore =−

(qualitySettings.scorePerSecond.get(info.metric) * (info.time −
prevTime)/ 1000);

```
  }
  prevTime = info.time;
}
if(startingScore >= qualitySettings.minAwardImmediatly) {
  return QualityScore.AwardImmediatly;
}
if(startingScore >= qualitySettings.minAwardImmediatly) {
  return QualityScore.minRequireCaptcha;
}
return QualityScore.NoAward
```

```
  }
  static class QualitySettings {
```

Map<QualityMetric, Integer> scorePerInstance;
Map<QualityMetric, Integer> scorePerSecond;
int startingScore;
int minAwardImmediatly;
int minRequireCaptcha;

```
  }
  static class TransactionQualityInfo {
```

```
public QualityMetric metric;
public long time;
public TransactionQualityInfo(QualityMetric metric) {
  this.metric = metric;
  this.time = System.currentTimeMills( );
}
```

```
  }
  enum QualityMetric {
```

TransactionStart, WindowFocus, WindowResize, InputFocus,

```
MouseMovement, TimeZoneChange, TransactionEnd;
  }
  enum QualityScore {
```

AwardImmediatly, RequireCaptcha, NoAward;

}
}

After a quality algorithm calculates a quality score for the transaction, the score is stored in the Quality Score column 84 of the Transaction History table 60. The reward application then may determine whether the quality score is sufficient to authenticate the quality of the transaction 106. If the quality score is sufficient 108, then the reward application will increment the count in the TierQty column 71 of the Transaction Summary table 58.

By contrast, if the quality score is not sufficient 110 to authenticate the transaction directly, the rewards application will determine whether the transaction quality score is sufficient to allow captcha 112. If the quality score is sufficient 114, then the rewards application will set the Boolean data in the EnforceCaptcha column of the transaction summary table to enforce captcha 116, and then increment the count 118 in the TierQty column 74 of the Transaction Summary table. If the quality score is less than a minimum acceptable score 120, the rewards application rejects the transaction and waits to process and evaluate data from the next transaction 92.

After the rewards application increments the count in the TierQty column 74 of the transaction summary database, the program assesses 122 whether the count in the TierQty column 74 equals the TierRQty setting in the Contest table. If the count is less than the setting 124, then the rewards application sends a new meter to the user interface 126 which shows the current value of the TierQty parameter, and then waits to process and evaluate data from the next transaction 92.

If the count in the user's TierQty column is equal or greater than the TierRQty setting 128, then the reward application determines whether the EnforceCaptcha parameter for the given UserID in the transaction summary table is set to require user captcha 130.

If user captcha is required 132, then the rewards engine sends a captcha screen to the end user device 134. The response is evaluated to determine whether it matches the captcha 138. If the response fails to match the captcha 140, the rewards application determines whether a maximum limit for the number of unsuccessful captcha attempts has been exceeded 142. If the maximum limit has not been exceeded 144, then another captcha screen is delivered to the end user device. If the maximum limit has been exceeded 146, then the rewards application starts to process and evaluate data from the next transaction 92 without awarding an incentive to the end user. If the response from the end user device matches the captcha 148, then the reward engine awards an incentive to the end user 150 and sends a congratulations screen (or message) to the end user device 152.

The reward application completes the transaction-reward cycle (or incentivized activity process) by resetting the count in the TierQty column to zero 154, before starting to process and evaluate data from the next transaction 92.

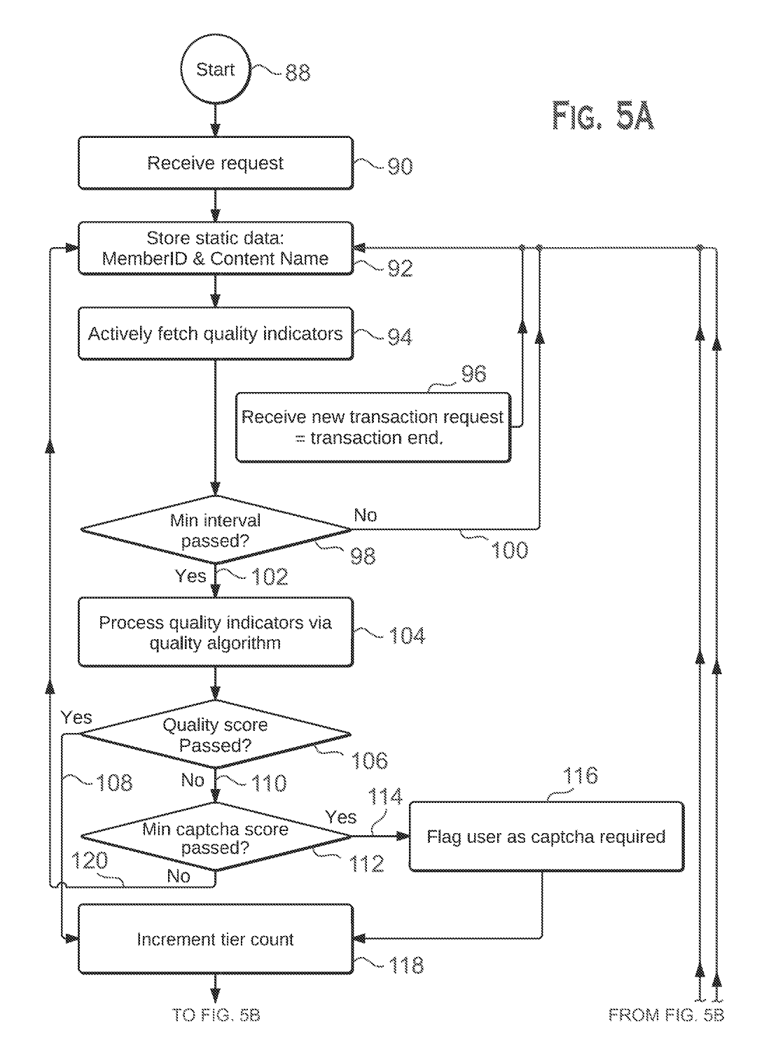

Referring to FIG. 4, a method of monitoring and rewarding a participant for engaging in an incentivized activity provides an incentive such as scrip or virtual currency. The method involves the steps of starting the activity 151, prompting the user for interaction 153, finishing the activity 155, and awarding an incentive to the user 157. As FIG. 4 shows, the incentive may be partially or fully based on user interaction during the incentivized activity.

In an alternative embodiment that is schematically depicted in FIG. 5, the incentive may be partially or fully based upon the quality of the individual's participation in the incentivized activity. This method involves the steps of starting the activity 159, monitoring the quality of the end user participation with the activity 161, finishing the activity 163, and awarding an incentive to the user 165.

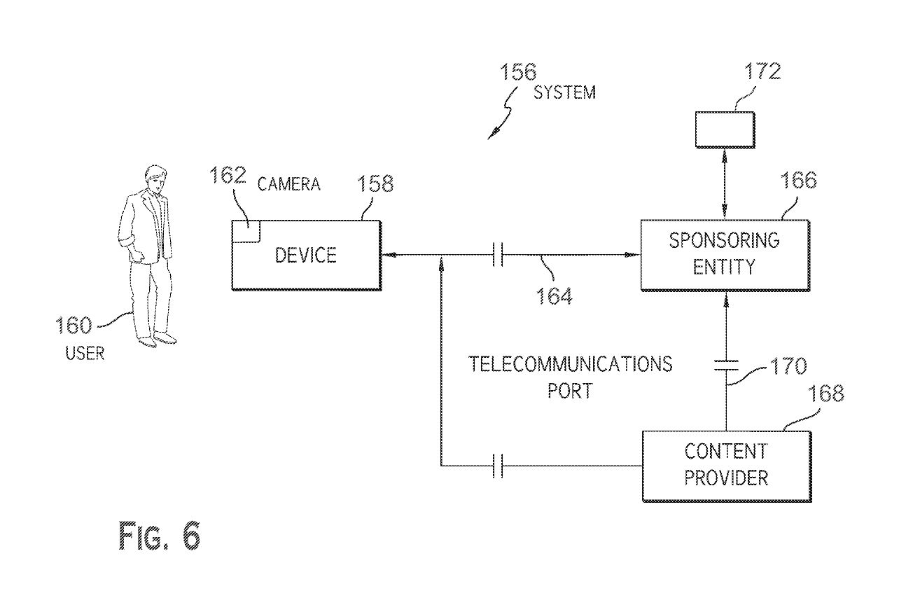

FIG. 6 depicts another system 156 for monitoring and rewarding an incentivized activity that is constructed according to an embodiment of the present invention. System 156 preferably includes an electronic device 158, which may be, without limitation, a personal computer, a mobile device such as a tablet computer or smart phone, a gaming console, or an interactive television system. A user 160 is situated before the electronic device 158. The electronic device 158 may include an integrated or electronically connected camera 162, as will be described in greater detail below. The electronic device 158 is preferably connected using a telecommunications path 164 such as the Internet to a backend server 166 that is operated by an entity who is sponsoring the incentivized activity.

The electronic device 158 is also preferably connected to a content provider 168 that provides the incentivized activity, such as a movie, web site, or television program. The content provider 168 also is preferably in communication with the sponsoring entity 166 through the telecommunications path 164 or through a dedicated information link. A business relationship 170 also preferably exists between the sponsoring entity 166 and the content provider 168. For example, financial compensation may be provided by the content provider 168 to the sponsoring entity 166 in exchange for providing the incentive for the participant 160 to view the content. The sponsoring entity 166 may further have a business relationship with one or more additional entities 172, such as organizations providing marketing analysis services.

In the preferred embodiment, the system 156 is provided within a website in which rewards for viewing a video are verified by user interaction. Alternatively, the incentivized activity could be a game, viewing one or more web sites, viewing advertisements on web sites, clicking on advertising links on web sites, engaging in an educational activity such as an online lecture, or using certain software such as shareware that has integrated advertising. The incentivized activity could be any online activity. The incentivized activity could be activity that takes place on a computer, on a television, or on a mobile device. The incentivized activity could be an activity that happens at home, in an educational environment, in the workplace, or while traveling using a mobile device.

For example, the incentivized activity could be activity that an employee is required to do on the computer in the workplace. It could be activity that a student is required to do away from the educational facility, such as at home, on a portable computing device, or mobile device.

In a preferred embodiment, the system 156 randomly awards scrip currency, points or prizes to users for watching videos, and most preferably awards virtual currency. Alternatively, the incentive could be fixed as opposed to random.

The incentive may be credited to the participant during the activity, when the activity is completed, or at a later time. It could be awarded all at once or incrementally as the participant progresses in the incentivized activity. Any variable can be used in order to determine the amount of the incentive that is to be rewarded, and when and how it is to be rewarded.

In one embodiment, the content provider 168 provides content that includes an Internet website including videos and further has a ‘meter’ whereby users watch a certain number of videos, or a certain amount of video time, their ‘score’ on the meter increases, and when they reach 100% (or ‘full’ or ‘complete’ or any such designation) on their meter, they are rewarded.

The reward can be in a virtual currency, points, or any of the numerous types of rewards used online. Data regarding the user's participation in the incentivized activity, as well as the user's entitlement to receive incentive, preferably are linked within the backend server 166 of the sponsoring entity with an identifiable account that is associated with the user. The user's account may be affiliated with the accounts of one or more additional users. The nature of the affiliation may be to permit group participation in the incentivized activity, such as for purposes of charitable fund raising. Alternatively, the affiliation that is tracked by the system could be social networking affiliations in which users can multilaterally interact with each other by sharing information regarding their participation in the incentivized activities. This may be integrated into a pre-existing social networking web site, or be completely supported by the system.

In another aspect of the invention, the system 156 is configured to reduce the likelihood of a user 160 opening a video file and “walking away” or minimizing the video player, which could occur if rewards were given for simply initiating the video or running the video to completion. The system 156 also may be able to detect whether the window hosting the incentivized activity is partially or fully obscured by one or more other windows running on the participant's computer.

It is valuable for an entity 166 that sponsors the incentivized activity to be able to verify that a user has watched an entire video, and not simply initiate the video without paying attention. Therefore, it is preferred that questions appear during and/or after the video. The correct answer to the question will verify the user has watched the video and the reward will be greater, or there will be an additional reward, thereby providing incentive for the user to watch.

Preferably the system 156 is interactive, and, for one example, midway through a video the system will prompt a user with a trivia question related to the video they are watching. This prompt may appear inside the video player, may be a separate pop up window, or may be any feasible method. The user can be rewarded for any response, but the correct answer to this trivia question will generate the most points, virtual currency amount, etc. Most preferably, the correct answer will serve as a promotional code to be entered on a virtual currency website, and upon entry of the answer (now serving as a code), the user will be rewarded.

The questions that the participant 160 are asked may be integrated into other programs such as marketing surveys, which may serve as an additional source of revenue to the entity who is sponsoring the incentivized activity.

Alternatively, the participant 160 may be prompted to enter information into a captcha, simply click on a button that indicates that the participant is present or any other activity that indicates that the participant is in the vicinity of the computer. In the case of a mobile device, the user's participation in the incentivized activity could be monitored using an accelerometer that is built into the mobile device. This would enable the sponsor of the incentivized activity to ensure that the mobile device is actually being held by the participant.

In the case where the incentivized activity is watching content provided on a television, the user's participation in the incentivized activity could be monitored by requiring prompts that are entered by the user using a television or cable box remote control. Accordingly, the system could be integrated into a cable or satellite television system.

As another alternative, a camera 162 built-in or connected into the electronic device 158 can be used to verify the presence of the participant during the incentivized activity. It could also be used to collect data that can be used to evaluate the quality of the user's participation in the incentivized activity and/or the user's reaction to the incentivized activity. For example, a camera 162 that is built into a mobile device, such as a tablet computer, could be used to image the participant's face during the incentivized activity. Software then can be used to identify the individual and verify that it is the same individual who is linked to the individualized account that is being credited with the incentive. Software also could be used to gauge the participant's emotions during the incentivized activity, whether the participant is alert during the incentivized activity, when the participant is engaging and distracting activities such as talking to one or more other individuals, and so forth. This information could be sold by the entity that is sponsoring the incentivized activity to a rating service, or for other commercial purposes.

Although the present invention is described in terms of a virtual currency reward site, the invention lends itself to multiple applications. For example, certain video websites may wish to implement a points system for statistical reasons and not reward users with virtual currency or other items of actual value. Educational websites can use the system and the idea of generating points to measure student progress and reward levels of performance accordingly.

Although certain embodiments are described in terms of websites, the invention also could be embodied for use with CD or DVD based technology, or any manner in which video or video-like content is stored and transmitted to a user for viewing in an interactive environment.

While the foregoing processes and mechanisms can be implemented by a wide variety of physical systems and in a wide variety of network and computing environments, the server or computing systems described below provide an example of acceptable computing system architectures.

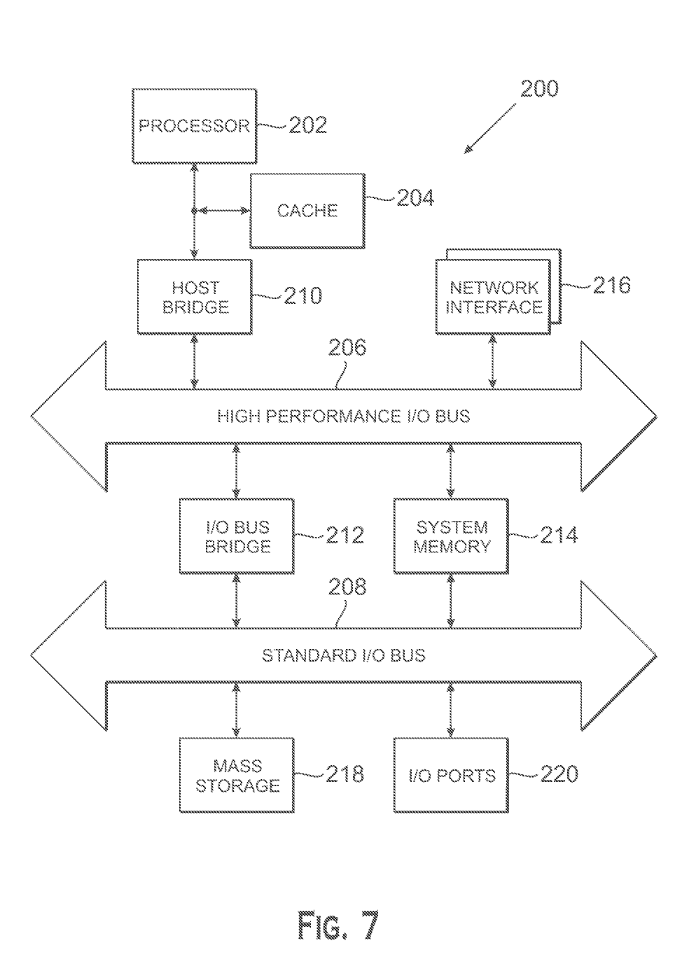

FIG. 7 illustrates exemplary computing system architecture, which may be used to implement a server 18, 20, or an end user device 12. In one embodiment, hardware system 200 comprises a processor 202, a cache memory 204, and one or more executable modules and drivers, stored on a tangible computer readable medium, directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and one or more network/communication interface 216 couple to bus 206. Hardware system 200 further may include video memory (not shown), and a display device coupled to the video memory. Mass storage 218, and I/O ports 220 may couple to bus 208. Hardware system 200 optionally may include a keyboard and pointing device, and a display device (not shown) coupled to bus 208. Collectively, these elements are intended to represent a broad category of computer hardware systems, including but not limited to, general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, a backplane, etc. Mass storage 218 provides permanent storage for the data and programming instructions to perform the above-described functions implemented in the servers 18, 20, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures, and various components of hardware system 200 may be rearranged. For example, cache 204 may be on-chip with processor 202. Alternatively, cache 204 and processor 202 may be packed together as a “processor module,” with processor 202 being referred to as the “processor core.”

Furthermore, certain embodiments of the present invention may neither require nor include all of the above components. For example, the peripheral devices shown coupled to standard I/O bus 208 may couple to high performance I/O bus 206. In addition, in some embodiments, only a single bus may exist, with the components of hardware system 200 being coupled to the single bus. In addition, hardware system 200 may include additional components, such as additional processors, storage devices, or memories.

In one implementation, the operations of the embodiments described herein are implemented as a series of executable modules run by hardware system 200, individually or collectively in a distributed computing environment. In a particular embodiment, a set of software modules and/or drivers implements a network communications protocol stack, parallel computing functions, browsing and other computing functions, optimization processes, and the like. The foregoing functional modules may be realized by hardware, executable modules stored on a computer readable medium, or a combination of both. For example, the functional modules may comprise a plurality or series of instructions to be executed by a processor in a hardware system, such as processor 202. Initially, the series of instructions may be stored on a storage device, such as mass storage 218. However, the series of instructions can be tangibly stored on any suitable storage medium, such as a diskette, CD-ROM, ROM, EEPROM, etc.

Furthermore, the series of instructions need not be stored locally, and could be received from a remote storage device, such as a server on a network, via network/communications interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft (r) Windows (r) operating systems, BSD operating systems, and the like.

Still, other implementations are possible. For example, the functions described herein may be implemented in firmware or on an application specific integrated circuit.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accordance with the invention. The term “processing system” refers to a single processing device or a group of inter-operational processing devices. Some examples of processing devices are integrated circuits and logic circuitry.

While it is apparent that the illustrative embodiments of the invention disclosed herein fulfill the objectives stated above, it is appreciated that numerous modifications and other embodiments may be devised by those skilled in the art. Features and/or elements from one embodiment may be used with other embodiments. Therefore, it will be understood that the present invention is intended to cover all such modifications and embodiments, which would come within the spirit and scope of embodiments of the present invention.

What is claimed is:

1. A method of awarding a reward to an end user account associated with an end user of a first information management system based on a qualifying number of validated transactions between the end user and a second information management system via a computing device user interface comprising:
associating a computing device, which comprises a user interface, with an end user account;
setting a qualifying number of validated transactions for earning a reward; establishing a counter for tracking the number of validated transactions of the end user;
setting first and second threshold quality values, the first threshold quality value being greater than the second threshold quality value;
establishing a communication channel between the user interface and the first information management system and monitoring DOM movements associated with the user interface during a transaction between the computing device and a second information management system;
calculating, using a microprocessor, a first quantitative measure of the level of interaction between the end user and the user interface during the transaction based on DOM movement data associated with the transaction;
calculating, using a microprocessor, a second quantitative measure of the level of interaction between the end user and the user interface during the transaction based on certain DOM movement data associated with the transaction;
comparing, using a microprocessor, the second quantitative measure to the first threshold quality value, and then validating the quality of the transaction based on the second qualitative measure;
counting a qualifying number of validated transactions; and
awarding a reward to the end user account based on the qualifying number of validated transactions between the end user and a second information management system via the computing device user interface.

2. The method of claim 1, further comprising deploying a hook into the user interface and monitoring DOM movements associated with the user interface during a transaction between the computing device and a second information management system using the hook.

3. The method of claim 2, wherein deploying the hook into the user interface comprises deploying the hook into an Internet web browser.

4. The method of claim 2, wherein deploying the hook into the user interface comprises deploying the hook into a mobile application.

5. The method of claim 2, wherein comparing the second quantitative measure to the first threshold quality value further comprises comparing the second quantitative measure to the second threshold quality value, and then flagging the user for captcha and incrementing the counter if the second qualitative measure is greater than the second threshold quality value.

6. The method of claim 2, wherein comparing the second quantitative measure to the first threshold quality value further comprises comparing the second quantitative measure to the second threshold quality value, and then waiting to monitor DOM movements associated with the user interface during a subsequent transaction between the computing device and a second information management system if the second qualitative measure is less than the second threshold quality value.

7. The method of claim 5, further comprising comparing the counter value to the qualifying number of validated transactions for earning a reward.

8. The method of claim 7, further comprising determining whether captcha is required.

9. The method of claim 8, further comprising delivering a captcha to the user interface.

10. The method of claim 9, further comprising delivering a meter to the user interface.

11. The method of claim 9, further comprising delivering another captcha to the user interface.

12. The method of claim 11, further comprising delivering a congratulations message to the user interface.

13. The method of claim 1, wherein the computing device is a personal computer.

14. The method of claim 13, wherein the computing device is a laptop computer.

15. The method of claim 1, wherein the computing device is a tablet computer.

16. The method of claim 1, wherein the computing device is a mobile phone.

17. The method of claim 16, wherein the computing device is a smart phone.

18. The method of claim 1, wherein the computing device is a gaming console.

19. The method of claim 1, wherein the computing device is a television.

20. The method of claim 1, wherein the reward is scrip currency.
